(19) United States
(12) Patent Application Publication
(10) Pub. No.: US 2025/0300311 A1
(43) Pub. Date: Sep. 25, 2025

(54) ENERGY STORAGE POWER SUPPLY

(71) Applicant: SHENZHEN HELLO TECH ENERGY CO., LTD, Shenzhen (CN)

(72) Inventors: Foming ZHANG, Shenzhen (CN); Yongjun CHEN, Shenzhen (CN); Gaosong SHEN, Shenzhen (CN)

(21) Appl. No.: 19/230,144

(22) Filed: Jun. 6, 2025

(30) Foreign Application Priority Data
Aug. 15, 2024 (CN) 202411125442.9
Aug. 15, 2024 (CN) 202421990396.4
Oct. 8, 2024 (CN) 202411399637.2
Oct. 8, 2024 (CN) 202422424315.0

(51) Int. Cl. H01M 50/325; H01M 50/186; H01M 50/213; H01M 50/24; H01M 50/244; H01M 50/264; H01M 50/358; H01M 50/507

(52) U.S. Cl. CPC H01M 50/325; H01M 50/186; H01M 50/213; H01M 50/24; H01M 50/244; H01M 50/264; H01M 50/358; H01M 50/507

(57) ABSTRACT

Provided is an energy storage power supply. The energy storage power supply includes cells, a housing, and a sealing member. The cells include electrodes and/or explosion-proof valves. A receiving chamber for receiving the cells is formed inside the housing. The housing has a mounting wall. A fixing structure for fixing the cells is formed at a side of the mounting wall close to the receiving chamber. The fixing structure has through holes corresponding to the cells. The electrodes and/or explosion-proof valves of the cells are in communication with an outside of the receiving chamber through the through holes. The sealing member covers a side of the mounting wall away from the receiving chamber to isolate the cells from an external environment.

### CROSS-REFERENCE TO RELATED APPLICATION

This application claims priorities to and benefits of Chinese patent applications Nos. 202411399637.2 and 202422424315.0, filed with China National Intellectual Property Administration on Oct. 8, 2024, which claim priority to Chinese patent applications Nos. 202411125442.9 and 202421990396.4, filed with China National Intellectual Property Administration on Aug. 15, 2024, the entire contents of which are incorporated herein by reference.

### FIELD

The present disclosure relates to the field of energy storage technologies, and more particularly, to a design of an energy storage power supply.

### BACKGROUND

Conventional energy storage power supply products generally contain a plurality of cells as their capacity increases. These cells are usually first assembled into a battery module, which is then mounted inside a case of an energy storage power supply.

### SUMMARY

The present disclosure aims to solve at least one of the technical problems in the related art. To this end, the present disclosure provides an energy storage power supply.

According to an embodiment of the present disclosure, an energy storage power supply includes cells, a housing, and a sealing member. A receiving chamber for receiving the cells is formed inside the housing. The housing has a mounting wall. A fixing structure for fixing the cells is formed at a side of the mounting wall close to the receiving chamber. The fixing structure has through holes corresponding to the cells. The cells are in communication with an outside of the receiving chamber through the through holes. The sealing member covers a side of the mounting wall away from the receiving chamber to isolate the cells from an external environment. One of the sealing member and the mounting wall has a groove formed at a periphery of the one of the sealing member and the mounting wall. Another of the sealing member and the mounting wall has a protrusion formed at a periphery of the other of the sealing member and the mounting wall. The protrusion is inserted into the groove.

In some embodiments, the groove is filled with an adhesive.

In some embodiments, an elastic sealing member is disposed in the groove, the protrusion abutting with the elastic sealing member.

In some embodiments, the sealing member is a cover plate, and the mounting wall has a mounting recess formed at the side of the mounting wall away from the receiving chamber. The through holes are formed at a bottom of the mounting recess. The cover plate covers the mounting recess. The groove is formed at a periphery of the mounting recess. The protrusion is formed at a periphery of the cover plate.

In some embodiments, the mounting wall and the sealing member form a receiving space, and electrodes of the cells are in communication with the receiving chamber through the through holes. A busbar is disposed in the receiving space and electrically connected to the electrodes of the cells.

In some embodiments, the mounting wall and the sealing member form a receiving space, explosion-proof valves being in communication with the receiving space through the through holes.

In some embodiments, a pressure relief channel is formed in the receiving space, the receiving space being in communication with the receiving chamber or an outside of the housing through the pressure relief channel.

In some embodiments, the mounting wall is formed at a bottom of the housing.

In some embodiments, the fixing structure is an accommodation recess, the cells being inserted into the accommodation recess at ends of the cells, and the through holes being formed at a bottom of the accommodation recess.

In some embodiments, one of the mounting wall and the sealing member is provided with a support structure abutting with another one of the mounting wall and the sealing member.

In some embodiments, the support structure is a support post. One of the mounting wall and the sealing member is provided with the support post, and another one of the mounting wall and the sealing member has a support recess. The support post being inserted into the support recess.

In some embodiments, the energy storage power supply further includes a fixing support connected to an inner wall of the receiving chamber to fix the cells to the fixing structure.

In some embodiments, the energy storage power supply further includes an inverter disposed in the receiving chamber and electrically connected to the cells. The inverter is fixedly disposed at the fixing support.

According to an embodiment of the present disclosure, an energy storage power supply includes: a plurality of cells comprising electrodes and/or explosion-proof valves; a housing having a mounting wall, a receiving chamber for receiving the plurality of cells being formed inside the housing, a fixing structure for fixing the plurality of cells being formed at a side of the mounting wall close to the receiving chamber, the fixing structure having through holes corresponding to the plurality of cells, and the electrodes and/or explosion-proof valves of the plurality of cells being in communication with an outside of the receiving chamber through the through holes; and a sealing member covering a side of the mounting wall away from the receiving chamber to isolate the plurality of cells from an external environment, one of the sealing member and the mounting wall being provided with a support structure abutting with another one of the mounting wall and the sealing member.

In some embodiments, the support structure is a support post, one of the mounting wall and the sealing member is provided with the support post, and another one of the mounting wall and the sealing member has a support recess, the support post abutting with the other of the mounting wall and the sealing member.

In some embodiments, another one of the mounting wall and the sealing member has a support recess, the support post being inserted into the support recess.

In some embodiments, one of the sealing member and the mounting wall is provided with a snap; and the support structure is a hook, the snap being in a snap-fit connection with the hook.

In some embodiments, the sealing member is provided with a reinforcing rib, the support structure being disposed at the reinforcing rib.

In some embodiments, the mounting wall is formed at a bottom of the housing.

In some embodiments, one of the sealing member and the mounting wall has a groove formed at a periphery of the one of the sealing member and the mounting wall; and another one of the sealing member and the mounting wall has a protrusion formed at a periphery of the other of the sealing member and the mounting wall, the protrusion being inserted into the groove.

In some embodiments, the groove is filled with an adhesive.

In some embodiments, an elastic sealing member is disposed in the groove, the protrusion abutting with the elastic sealing member.

In some embodiments, the sealing member is a cover plate, and the mounting wall has a mounting recess formed at the side of the mounting wall away from the receiving chamber. The through holes are formed at a bottom of the mounting recess. The sealing member covers the mounting recess. The mounting recess has a groove formed at a periphery of the mounting recess. The sealing member has a protrusion formed at a periphery of the sealing member.

In some embodiments, the mounting wall and the sealing member form a receiving space, the electrodes of the plurality of cells being in communication with the receiving space through the through holes, and a busbar is disposed in the receiving space and electrically connected to the electrodes of the plurality of cells.

In some embodiments, the mounting wall and the sealing member form a receiving space, the explosion-proof valves being in communication with the receiving space through the through holes.

In some embodiments, a pressure relief channel is formed in the receiving space, the receiving space being in communication with the receiving chamber or an outside of the housing through the pressure relief channel.

In some embodiments, the fixing structure is an accommodation recess, the plurality of cells being inserted into the accommodation recess at ends of the plurality of cells, and the through holes being formed at a bottom of the accommodation recess.

In some embodiments, the energy storage power supply further includes a fixing support connected to an inner wall of the receiving chamber to fix the plurality of cells to the fixing structure.

In some embodiments, the energy storage power supply further includes an inverter disposed in the receiving chamber and electrically connected to the plurality of cells.

In this way, in the energy storage power supply of the present disclosure, the cells are received in the receiving chamber inside the housing, and the through holes in the mounting wall of the housing are designed for connecting the electrodes and/or explosion-proof valves of the cells to an external device. The design where the protrusion of the one of the sealing member and the mounting wall is inserted into the groove of the other of the sealing member and the mounting wall ensures a tight engagement between the sealing member and the housing, effectively preventing water and other external substances from penetrating through a seam between the sealing member and the housing into a case.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic structural view of an energy storage power supply according to an embodiment of the present disclosure.

FIG. 2 is a first schematic exploded view of an energy storage power supply according to an embodiment of the present disclosure.

FIG. 3 is a second schematic exploded view of an energy storage power supply according to an embodiment of the present disclosure.

FIG. 4 is a first schematic view of a sealing member covering a housing according to an embodiment of the present disclosure.

FIG. 5 is a second schematic view of a sealing member covering a housing according to an embodiment of the present disclosure.

FIG. 6 is a schematic structural view of a housing (excluding a cell) according to an embodiment of the present disclosure.

FIG. 7 is a schematic structural view of a cell according to an embodiment of the present disclosure.

FIG. 8 is a schematic structural view of a housing (including a cell) according to an embodiment of the present disclosure.

FIG. 9 is a partially enlarged schematic structural view of part A in FIG. 1.

FIG. 10 is a cross-sectional view of the energy storage power supply in FIG. 1 taken along line B-B.

FIG. 11 is a partially enlarged schematic structural view of part D in FIG. 10.

FIG. 12 is a partially enlarged schematic structural view of part C in FIG. 10.

FIG. 13 is a third schematic exploded view of an energy storage power supply according to an embodiment of the present disclosure.

FIG. 14 is a partially enlarged schematic structural view of part E in FIG. 13.

Reference numerals of main components in the accompanying drawings:
energy storage power supply 100, housing 10, receiving chamber 101, accommodation recess 102, mounting wall 11, through hole 111, mounting recess 112, support recess 113, supporting post 12, elastic sealing member 13, sealing member 20, support post 21, transverse reinforcing rib 23, longitudinal reinforcing rib 24, cell 30, body 31, first pole 32, second pole 33, explosion-proof valve 34, receiving space 40, busbar 50, first busbar 501, second busbar 502, collection board 60, first collection board 601, second collection board 602, sealing ring 70, fixing support 80.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, and “anti-clockwise” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

In the description of the present disclosure, it should be noted that, unless otherwise clearly specified and limited, terms such as “install”, “connect”, and “connect to” should be understood in a broad sense. For example, it may be a fixed connection or a detachable connection or connection as one piece; mechanical connection, electrical connection, or mutual communication; direct connection or indirect connection through an intermediate; internal communication of two components or the interaction relationship between two components. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Various embodiments or examples for implementing different structures of the present disclosure are provided below. In order to simplify the description of the present disclosure, components and arrangements of specific examples are described herein. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed arrangements.

In addition, the present disclosure provides examples of various specific processes and materials. However, applications of other processes and/or the use of other materials are conceivable for those of ordinary skill in the art.

A cell-to-pack battery product structure is an innovative battery pack design, which abandons a stage of a conventional battery module and directly integrates cells into a case or a frame of the battery pack. This design aims to improve an energy density of a battery system, reduce a weight, lower costs, and simplify manufacturing and assembly of the battery pack.

In the cell-to-pack battery product structure, the cells are directly fixedly onto the case, which results in a partial exposure or a full exposure of the cells, posing challenges to sealing of the battery pack. When the sealing is unsatisfactory or a sealing member ages or gets damaged, external substances such as water is likely to penetrate into the case through a disassembly port, leading to issues such as short circuits or corrosion of the cells. An exposed part of the cells is particularly vulnerable to becoming a channel for water penetration.

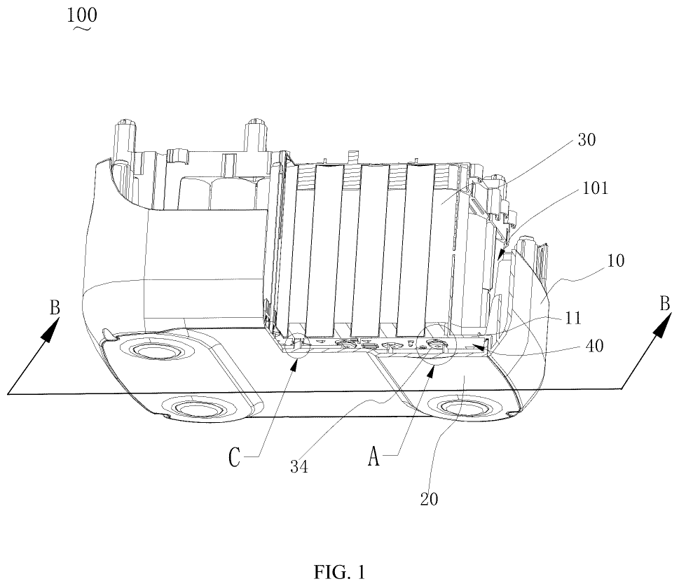

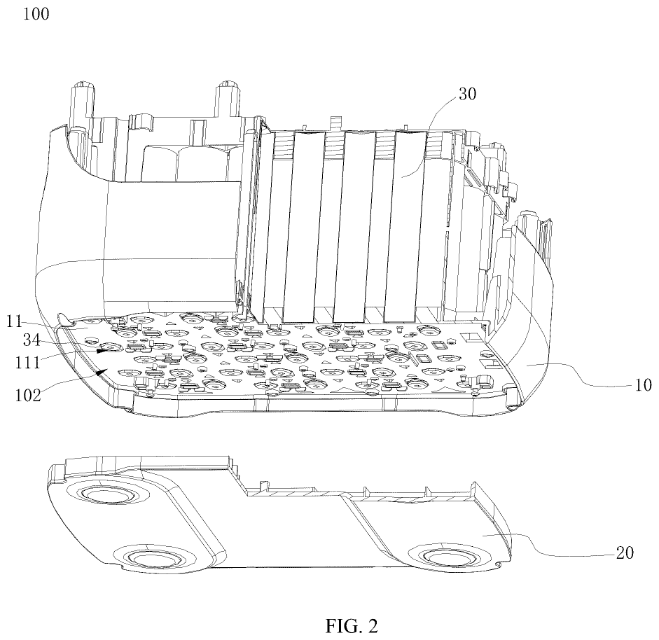

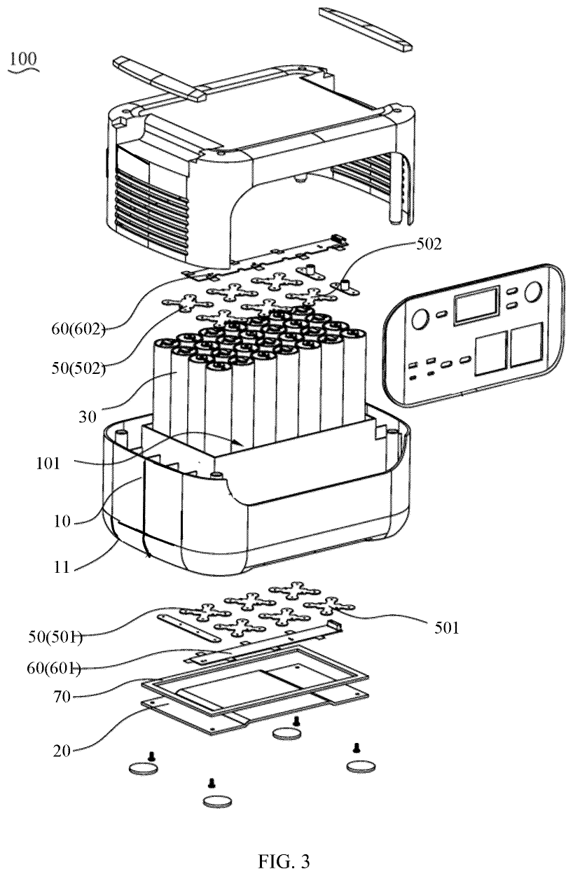

In view of this, as illustrated in FIG. 1, FIG. 2, and FIG. 3, an energy storage power supply 100 is provided according to embodiments of the present disclosure. The energy storage power supply 100 includes a housing 10, a sealing member 20, and a plurality of cells 30. The plurality of cells include electrodes and/or explosion-proof valves 34. A receiving chamber 101 for receiving the plurality of cells 30 is formed inside the housing 10. The housing 10 has a mounting wall 11. A fixing structure for fixing the plurality of cells 30 is formed at a side of the mounting wall 11 close to the receiving chamber 101. The fixing structure has through holes 111 corresponding to the plurality of cells 30. The electrodes and/or the explosion-proof valves 34 of the plurality of cells 30 are in communication with an outside of the receiving chamber 101 through the through holes 111. The sealing member 20 covers a side of the mounting wall 11 away from the receiving chamber 101 to isolate the plurality of cells 30 from an external environment. One of the sealing member 20 and the mounting wall 11 has a groove formed at a periphery of the one of the sealing member 20 and the mounting wall 11. Another one of the sealing member 20 and the mounting wall 11 has a protrusion formed at a periphery of the other of the sealing member 20 and the mounting wall 11. The protrusion is inserted into the groove.

In this way, in the energy storage power supply 100 of the present disclosure, the plurality of cells 30 are received in the receiving chamber 101 inside the housing 10, and the through holes 111 in the mounting wall 11 of the housing 10 are designed for connecting the plurality of cells 30 to an external device. The protrusion of the one of the sealing member 20 and the mounting wall 11 is inserted into the groove of the other of the sealing member 20 and the mounting wall 11, in this way, the design ensures a tight engagement between the sealing member 20 and the housing 10, effectively preventing water and other external substances from penetrating through a seam between the sealing member 20 and the housing 10 into a case.

Specifically, the energy storage power supply 100 is made of plastic, which has a low density, high strength, and a satisfactory insulation property, contributing to ensuring safety of the plurality of cells 30.

Alternatively, in an embodiment, the energy storage power supply 100 according to the embodiments of the present disclosure can be applied in an outdoor power supply for a user to use outdoors. For example, during camping, the user can use the energy storage power supply 100 to power or charge appliances, lights, mobile phones, tablet computers, etc.

Alternatively, in an embodiment, the energy storage power supply 100 according to the embodiments of the present disclosure can also be applied in an indoor power supply for the user to use indoors. For example, the user can charge the energy storage power supply 100 using an external power source. In the event of a power outage at home, the user can use the energy storage power supply 100 to power appliances, lights, mobile phones, tablet computers, etc.

The energy storage power supply 100 includes the housing 10, the sealing member 20, and the cells 30. The receiving chamber 101 for receiving the cells 30 is formed inside the housing 10, providing a stable and safe storage environment for the cells 30. The housing 10 further enables the cells 30 and other internal components to be firmly fixed at designated positions through an internal structure and a fixture of the housing 10, preventing the cells 30 and the other internal components from loosening or moving during transportation or use.

Since the sealing member 20 covers the mounting wall 11 of the housing 10 to isolate the mounting wall 11 from the external environment, water, dust, and other external substances are effectively prevented from entering the housing 10 through the mounting wall 11, which protects the cells 30 and other internal components from contamination and damage.

Further, one of the sealing member 20 and the mounting wall 11 has a groove formed at a periphery of the one of the sealing member 20 and the mounting wall 11, and another one of the sealing member 20 and the mounting wall 11 has a protrusion formed at a periphery of the other of the sealing member 20 and the mounting wall 11. The protrusion is inserted into the groove. The insertion may be implemented in the following two configurations.

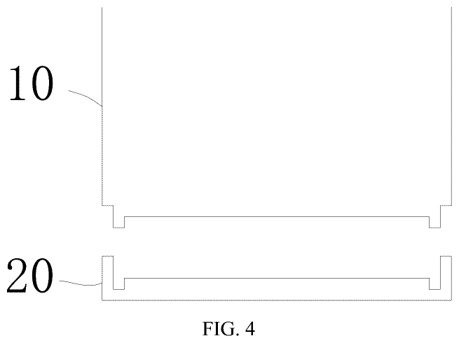

As illustrated in FIG. 4, the groove is formed at the periphery of the sealing member 20, and the protrusion is formed at the periphery of the mounting wall 11. In this way, this configuration provides more stable support and fixation.

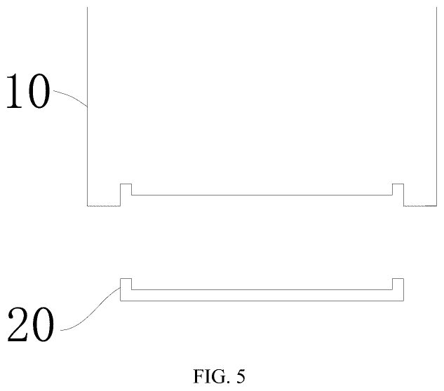

As illustrated in FIG. 5, the protrusion is formed at the periphery of the sealing member 20, and the groove is formed at the periphery of the mounting wall 11. In this way, this configuration allows for more convenient disassembly of the sealing member 20.

Regardless of the configuration, satisfactory sealing effectiveness can be achieved, as long as the protrusion and the groove are designed reasonably and tightly engaged with each other.

The cell 30 may be a secondary battery or a primary battery, which may be a lithium-sulfur cell, a sodium-ion cell, or a magnesium-ion cell. The cell 30 may be in a shape of a cylinder, a flat body, a rectangular body, or other shapes. In this embodiment, as an example, the cell 30 may be described as a cylinder. One or a plurality of cells 30 is disposed in the receiving chamber 101. The plurality of cells 30 may be electrically connected in series, in parallel, or in series and in parallel. The plurality of cells 30 being electrically connected in series and in parallel involves both a series connection and a parallel connection among the plurality of cells 30. Each cell 30 includes two electrodes and the explosion-proof valve 34.

The two electrodes are disposed at two ends of the cell 30, respectively, and one electrode and/or the explosion-proof valve 34 may be in communication with the outside of the receiving chamber 101 through the through hole 111.

In some embodiments, the groove is filled with an adhesive.

Specifically, water may accumulate on the ground or the ground may be wet, in which case moisture is likely to enter through a gap at a junction of the groove and protrusion. To address this, the groove can be filled with the adhesive, which can not only bond the sealing member 20 to the housing 10, but also provide waterproofing.

A material of the adhesive should exhibit satisfactory waterproofing, moisture resistance, corrosion resistance, insulation properties, or the like, which may be a polyurethane adhesive or an acrylic adhesive. The polyurethane adhesive is commonly used due to its adequate bonding performance and water resistance. A molecular structure of the polyurethane adhesive contains numerous urethane bonds, which provide relatively high cohesion and adhesion for the polyurethane adhesive, enabling the polyurethane adhesive to firmly bond various materials such as metal, plastic, and rubber. In addition, the polyurethane adhesive further exhibits adequate water resistance and weather resistance, maintaining bonding effectiveness over time in humid or harsh environments. Similarly, the acrylic adhesive also offers adequate bonding performance and waterproofing capabilities. A molecular structure of the acrylic adhesive contains many acrylate groups, which impart relatively high reactivity and adhesion to the acrylic adhesive, allowing rapid curing and forming strong chemical bonds with a surface of a bonded object. Further, the acrylic adhesive demonstrates satisfactory water resistance and resistance to chemical media, maintaining stable bonding performance in water or diverse chemical media.

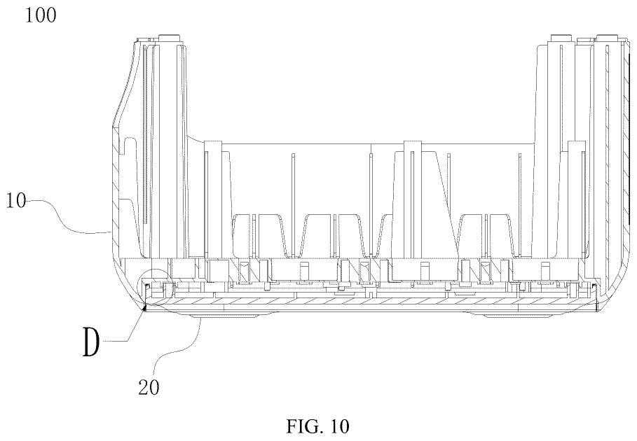

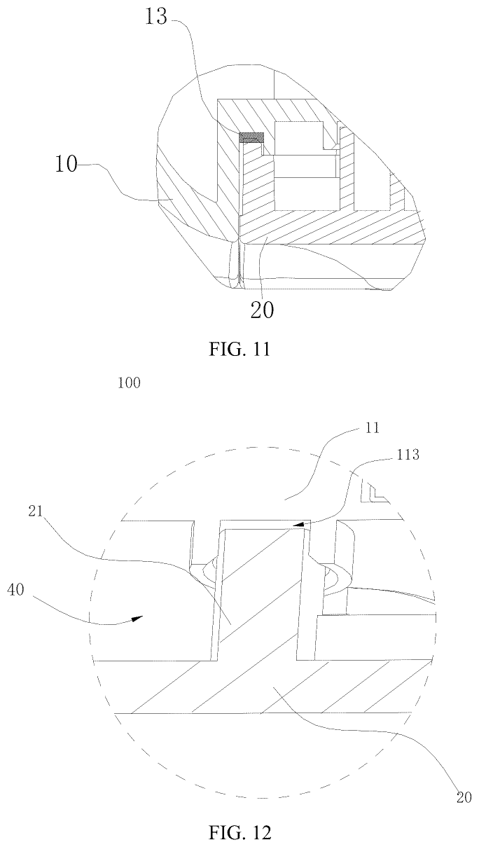

As illustrated in FIG. 10 and FIG. 11, in some embodiments, an elastic sealing member 13 is disposed in the groove. The protrusion abuts with the elastic sealing member 13.

Specifically, a primary function of the elastic sealing member 13 is to provide sealing effectiveness to prevent water, dust, and other external substances from entering the case through a gap, protecting the cells 30 and other components inside the case from contamination and damage.

The elastic sealing member 13 is placed within the groove and tightly attached to a wall surface of the groove. Such a design ensures a gap-free connection between the sealing member and the housing 10, improving reliability of the sealing.

Since the protrusion abuts with the elastic sealing member 13, the protrusion compresses the elastic sealing member 13 inside the groove when the groove is engaged with the protrusion, causing the elastic sealing member 13 to deform further and snugly fill any small gaps between the groove and protrusion. Such an abutment not only enhances the sealing effectiveness but also increases connection stability.

The elastic sealing member 13 may be made of a material having satisfactory elasticity and resistance to aging, such as rubber and silicone. These materials can maintain stable performance over long-term use, resisting aging and hardening.

As illustrated in FIG. 2, in some embodiments, the sealing member 20 is a cover plate, and the mounting wall 11 has a mounting recess 112 formed at the side of the mounting wall 11 away from the receiving chamber 101. The through holes 111 are formed at a bottom of the mounting recess 112. The sealing member 20 covers the mounting recess 112. The groove is formed at a periphery of the mounting recess 112. The protrusion is formed at a periphery of the sealing member 20.

Specifically, the groove is formed at the periphery of the mounting recess 112 on the mounting wall 11. A shape and a size of the groove match those of the protrusion of the sealing member 20, ensuring that the sealing member 20 can be accurately placed in the mounting recess 112 to realize positioning and fixation.

The through holes 111 formed at the bottom of the mounting recess 112 are used for an electrical connection, allowing a current or the like to pass through to meet operational needs of the cells 30 in the housing 10.

A plurality of supporting posts 12 for providing support is further disposed in the housing 10, which protects the cells 30 and other electronic components in the housing from damage due to a compression.

The protrusion at the periphery of the sealing member 20 aligns naturally with and is inserted into the groove. As the sealing member 20 is compressed down further, the protrusion deforms by a predetermined extent under a compression from the groove to be in tight contact with the wall surface of the groove. Such contact not only achieves a physical connection between the sealing member 20 and the housing 10 but also enhances stability and sealing of the connection through a compression force between the protrusion and the groove. The tight contact and the compression force between the protrusion and the groove achieve satisfactory sealing effectiveness, effectively preventing water, dust, and other external substances from entering the housing 10.

As illustrated in FIG. 1 and FIG. 3, in some embodiments, the mounting wall 11 and the sealing member 20 form a receiving space 40. The electrodes of the plurality of cells 30 are in communication with the receiving chamber 40 through the through holes 111. A busbar 50 is disposed in the receiving space 40 and electrically connected to the electrodes of the plurality of cells 30.

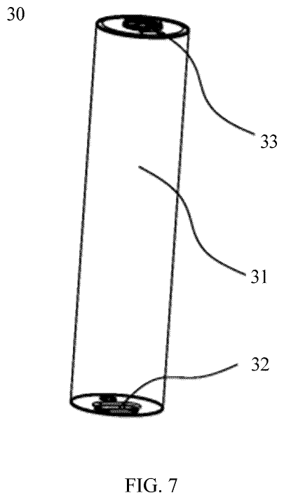

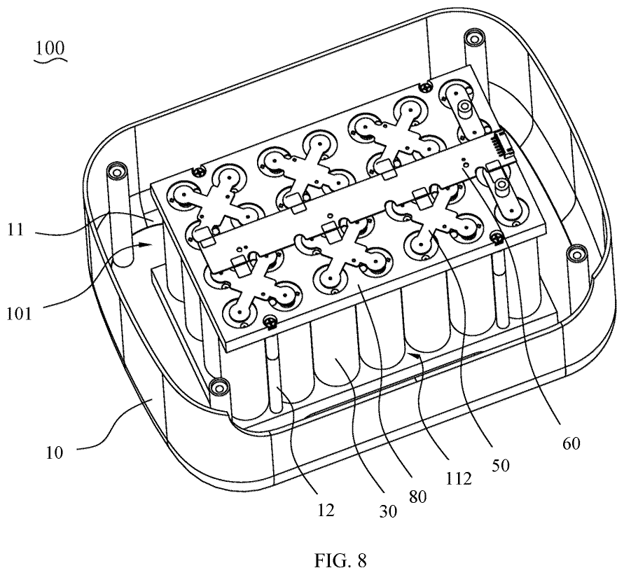

As illustrated in FIG. 7 and FIG. 8, the cell 30 may be cylindrical in shape. Each cell 30 includes a body 31, a first pole 32, and a second pole 33. The first pole 32 and the second pole 33 are disposed at two ends of the body 31 in a length direction of the body 31. The cell 30 may be vertically placed in the receiving chamber 101. A vertical direction of the cell 30 corresponds to the length direction of the body 31 of the cell 30.

The busbar 50 is a metallic strip or a metallic plate and configured to collect and distribute a current. The busbar 50 may be made of copper, aluminum, nickel, or an alloy. After the busbar 50 is fixed at a correct position using a working jig, the busbar 50 can be welded to the first pole 32 or the second pole 33 of the cell 30 through laser welding. It should be noted that, the busbar 50 and the pole of the cell 30 may also be electrically connected through other connection methods, such as stranding or crimping.

The electrodes of the plurality of cells 30 are connected by the busbar 50 to form an integrated current transmission network. In this way, the current can be ensured to flow evenly through the cells 30, improving overall performance and safety of the battery module.

The energy storage power supply 100 may further include a collection board 60, which is a circuit board specifically designed to collect status information from the cell 30. Using a high-precision sensor or measurement circuit, the collection board 60 collects analog signals such as a voltage, a current, and a temperature from the cell 30 and converts the analog signals into digital signals for subsequent processing. Through real-time monitoring and collection of the status information of the cell 30, an operation condition of the cell 30 can be accurately obtained for a timely implementation of corresponding control measures, which therefore avoids potential safety risks such as overcharging, over-discharging, and overheating of the cell 30, extending a service life of the cell 30 and improving performance of the cell 30.

The busbar 50 includes a first busbar 501 and a second busbar 502. The collection board 60 includes a first collection board 601 and a second collection board 602. The first collection board 601 may be fixed to a corresponding part of the first busbar 501 using a screw, while the second collection board 602 may be fixed to a corresponding part of the second busbar 502 using a screw. After fixation of the collection board 60, a nickel strip of the first collection board 601 may be connected to the first busbar 501 using laser welding or other electrical connection methods, achieving an electrical connection between the first collection board 601 and the first busbar 501. The status information of the cell 30, including a voltage, a current, a temperature, or the like of the cell 30, may be collected by a collection assembly.

As illustrated in FIG. 3, a sealing ring 70 is disposed between the sealing member 20 and an outer side wall of the housing 10 to enhance the sealing effectiveness, isolating the busbar from external moisture.

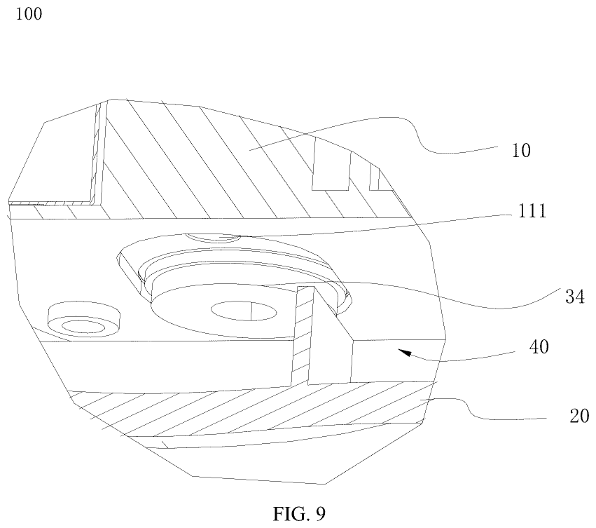

As illustrated in FIG. 9, in some embodiments, the mounting wall 11 and the sealing member 20 form the receiving space 40, and the explosion-proof valves are in communication with the receiving space 40 through the through holes 111.

The explosion-proof valves 34 is mounted at the cells 30 and in communication with the receiving space 40 through the through holes 111. A primary function of mounting the explosion-proof valve 34 at the cell 30 is to automatically release a pressure when an internal pressure of the cell 30 becomes excessively high, preventing the cell 30 from exploding. When the internal pressure of the cell 30 exceeds a predetermined threshold, the explosion-proof valve 34 is automatically activated or ruptures for allowing a gas or a liquid inside the cell 30 to be rapidly discharged to an outside of the receiving space 40, reducing the internal pressure of the cell 30. Consequently, during thermal runaway of the cell 30, a substance ejected from the explosion-proof valve 34 can be sprayed through the through hole 111 into the receiving space 40, preventing spread of the thermal runaway to a predetermined extent.

Specifically, during operation of the cell 30, the gas may be released inside the cell 30, causing an increase in the internal pressure of the cell 30. When the internal pressure becomes relatively high, the explosion-proof valve 34 may rupture to release the substance (such as a gas or a liquid) inside the cell 30. The explosion-proof valve 34 is in communication with the receiving space 40 through a first through hole 111, allowing the substance ejected from the explosion-proof valve 34 to be sprayed into the receiving space 40. The substance ejected from the explosion-proof valve 34 is isolated by the receiving space 40 from other cells 30 in the receiving chamber 101, preventing the spread of thermal runaway from one cell 30 to other cells 30 to a predetermined extent, enhancing safety of the energy storage power supply 100.

In some embodiments, a pressure relief channel is formed in the receiving space 40. The receiving space 40 is in communication with the receiving chamber 101 or an outside of the housing 10 through the pressure relief channel.

To further ensure safety, the receiving space 40 further has the pressure relief channel. The receiving space 40 is in communication with the receiving chamber 101 or the outside of the housing 10 through the pressure relief channel. The pressure relief channel allows the gas or the liquid in the receiving space 40 to be discharged smoothly to the external environment after the explosion-proof valve 34 releases the pressure, preventing an accumulation of the gas or the liquid in the receiving space 40 and potential hazards.

In some embodiments, the mounting wall 11 is formed at a bottom of the housing 10.

The mounting wall 11 is located at the bottom of the housing 10, providing stable support for the cell 30 or other mounted components. Such a design helps ensure stability of the cell 30 during operation, reducing a risk of damage caused by vibration or impact.

With the mounting wall 11 at the bottom of the housing 10, a seam between the sealing member 20 and the housing 10 is less visible on the one hand. On the other hand, gravity of the product as a whole can make an engagement between the sealing member 20 and the housing 10 more stable.

In addition, the mounting wall 11 at the bottom of the housing 10 may involve a heat dissipation design. If the cell 30 generates significant heat during operation, the bottom of the housing 10 can be designed to have a heat dissipation fin, a ventilation hole, or a structure connected to other heat dissipation systems to effectively dissipate the heat to the external environment.

As illustrated in FIG. 8, in some embodiments, the fixing structure is an accommodation recess 102. The cell 30 is inserted into the accommodation recess 102 at ends of the cell 30. The through holes 111 are formed at a bottom of the accommodation recess 102.

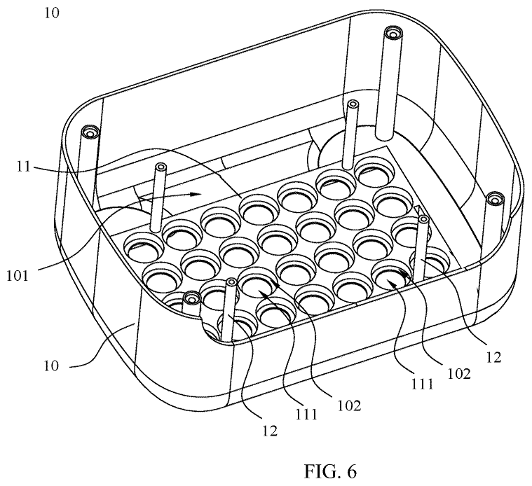

Alternatively, a plurality of accommodation recesses 102 may be formed and arranged in a matrix pattern, allowing the plurality of cells 30 to also be arranged in a matrix pattern. In this way, the plurality of cells 30 are in a relatively organized pattern, which is conducive to improving a spatial utilization efficiency of the energy storage power supply 100. A shape of the accommodation recess 102 is adapted to a shape of the cell 30, enabling more effective fixation and positional restriction of the cell 30. In FIG. 6, the cell 30 is in a shape of a cylinder, and the accommodation recess 102 is also in a shape of a cylinder.

In this way, the cell 30 can be restricted by the accommodation recess 102 to prevent the cell 30 from shaking during use of the energy storage power supply 100, preventing normal operation of the energy storage power supply 100 from being affected.

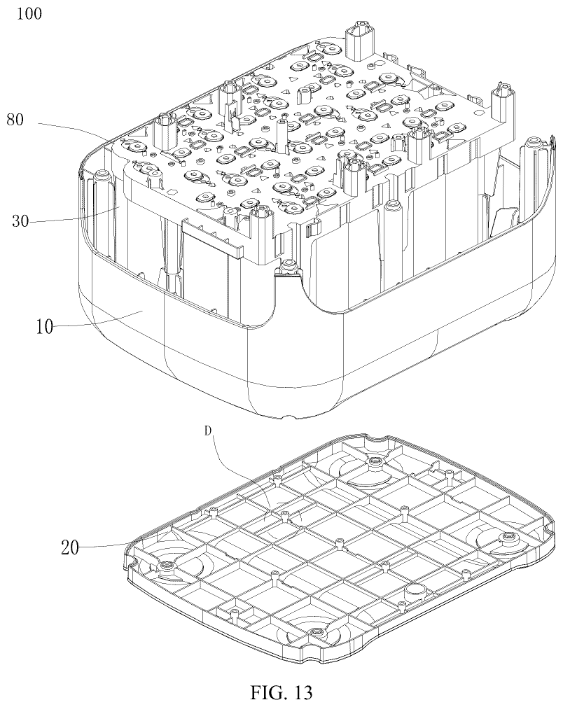

As illustrated in FIG. 8 and FIG. 13, in some embodiments, the energy storage power supply 100 includes a fixing support 80 connected to an inner wall of the receiving chamber 101 to fix the cells 30 to the fixing structure.

Specifically, the fixing support 80 is disposed in the receiving chamber 101 and fixedly connected to the inner wall of the receiving chamber 101. The fixing support 80 is disposed at an end of the cell 30 away from the fixing structure. The fixing support 80 and the fixing structure are capable of compressing the cell 30 in an up-down direction to ensure more stable fixation of the cell 30 in the receiving chamber 101. Therefore, the fixing support 80 can further enhance the stability of the cell 30.

In some embodiments, the energy storage power supply 100 further includes an inverter disposed in the receiving chamber 101 and electrically connected to the cells 30. The inverter is fixedly disposed at the fixing support 80.

Specifically, the inverter is one of the core components of the energy storage power supply 100. Disposing the inverter in the receiving chamber 101 allows the housing 10 to provide protection for the inverter. The inverter 16 is electrically connected to the cell 30 and is capable of converting a direct current from the cell 30 into an alternating current to supply power to an appliance using alternating currents. Alternatively, the energy storage power supply 100 is further capable of outputting the direct current to supply power to an electronic device using direct currents.

Further, the inverter 16 may be disposed at a side of the fixing support 80 away from the cell 30, in such a manner that the inverter 16 can be fixed using the fixing support 80, which can reduce an amount of additional components for fixing the inverter. In this way, a volume and a weight of the energy storage power supply 100 can be reduced to some extent, improving portability of the energy storage power supply 100 and lowering manufacturing costs of the energy storage power supply 100.

It should be understood that performance of the inverter directly affects an output quality and an operational efficiency of the energy storage power supply 100. Therefore, the inverter having a high conversion efficiency, high stability, and relatively satisfactory heat dissipation performance is prioritized in the design and selection. The inverter is fixed at the fixing support 82 to ensure a stable position of the inverter within the energy storage power supply 100 and facilitate heat dissipation and maintenance.

As illustrated in FIG. 1 and FIG. 12, in some embodiments, one of the mounting wall 11 and the sealing member 20 is provided with a support structure abutting with another one of the mounting wall and the sealing member 20.

In the battery module, the sealing member 20 is a relatively large plastic plate. If the sealing member 20 is only fixed around edges of the sealing member 20, depression or arching in a center of the sealing member 20 is likely to occur, which compromises overall structural stability and sealing performance of the energy storage power supply 100. To address this issue, the support structure may be disposed at one of the mounting wall 11 and the sealing member 20 to ensure flatness and stability of the sealing member 20.

The support structure is mounted at the mounting wall 11 or the sealing member 20 to ensure that the mounting wall 11 and the sealing member 20 can tightly abut with each other. When the support structure is disposed at the mounting wall 11, it is necessary to ensure that interference of the support structure with the cell 30 or other internal components is avoided. When the support structure is determined to be disposed at the sealing member 20, the support structure should be designed to match a corresponding part on the mounting wall 11 to ensure tight attachment during assembly.

The support structure may be designed as a plurality of point supports, post supports, or mesh supports, to distribute and support a weight of the sealing member 20. Point supports are suitable for small, irregularly shaped regions, providing stable support at critical positions to effectively avoid localized depression. A flexible design of the point supports can allow a precise adjustment based on a shape and a weight distribution of the sealing member 20. Through the precise arrangement of the point supports, an impact of the point supports on an overall appearance and a structure of the sealing member 20 can be minimized while maintaining aesthetics and functionality of the product. However, the point supports may have limitations in terms of coverage of support and relatively high requirements on material strength. The post supports are composed of a plurality of arrays of cylinders, offering relatively high structural strength and rigidity to withstand relatively great pressure and loads. The mesh supports are formed by a plurality of sheet-like supports interwoven into meshes, which performs satisfactorily in terms of structural strength, material savings, and heat dissipation. However, fabrication and mounting of the mesh supports are relatively complex.

As illustrated in FIG. 12 to FIG. 14, in some embodiments, the support structure is a support post 21. One of the mounting wall 11 and the sealing member 20 is provided with the support post 21. Another one of the mounting wall 11 and the sealing member 30 has a support recess 113. The support post 21 is inserted into the support recess 113.

In this embodiment, the support posts 21 are evenly distributed at the sealing member 20, and the support recesses 113 engaged with the support posts 21 are evenly distributed at the mounting wall 11. On one hand, an abutment between the support post 21 and the support recess 113 can provide support, which prevents the sealing member 20 from depressing and compressing the busbar or avoids a deformation of the sealing member 20, preventing the appearance of the sealing member 20 from being affected.

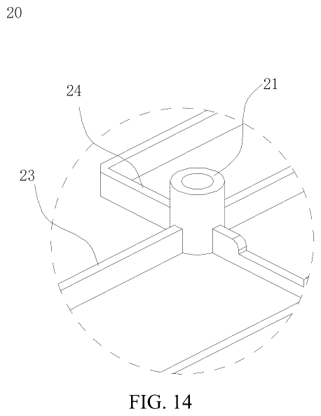

As illustrated in FIG. 13 and FIG. 14, in some embodiments, the sealing member 20 is provided with a reinforcing rib. The support structure is disposed at the reinforcing rib.

It should be noted that the reinforcing rib is a structural element arranged internally or externally to a structural body. Typically appearing in a plate-like shape, a strip-like shape, or other shapes, the reinforcing rib is used to strengthen a load-bearing capacity and stability of an original structure.

The reinforcing rib protrudes from the sealing member 20 towards the housing 10, and can take a shape of a mesh, a honeycomb, or the like. The shape of the reinforcing rib is not limited to any of these examples. For example, as illustrated in FIG. 13, the reinforcing rib is in a shape of a mesh. The reinforcing rib includes a plurality of transverse reinforcing ribs 23 and a plurality of longitudinal reinforcing ribs 24. An extension direction of the transverse reinforcing rib 23 is perpendicular to an extension direction of the longitudinal reinforcing rib 24. The support structure is disposed at an intersection of the transverse reinforcing rib 23 and longitudinal reinforcing rib 24. The transverse reinforcing rib 23 extends in a width direction or a short side direction of the structure and is mainly used to enhance rigidity and strength of the structure in a transverse direction. The transverse reinforcing rib 23 can effectively resist a lateral pressure or a lateral shear force, preventing an excessive deformation or damage of the structure in the transverse direction. The longitudinal reinforcing rib 24 extends in a length direction or a long side direction of the structure and is mainly used to enhance the rigidity and the strength of the structure in a longitudinal direction. The longitudinal reinforcing rib 24 can withstand a tensile force or a compression force applied from two ends of the structure, ensuring stability of the structure in the longitudinal direction. When the extension directions of the plurality of transverse reinforcing ribs 23 and the plurality of longitudinal reinforcing ribs 24 are perpendicular to each other, a mesh-like structural system is formed by the plurality of transverse reinforcing ribs 23 and the plurality of longitudinal reinforcing ribs 24 together. This mesh-like structural system can more effectively distribute and bear loads from various directions, improving an overall load-bearing capacity and stability of the structure.

In this way, disposing the reinforcing rib at the sealing member 20 can increase rigidity and strength of the sealing member 20, enabling the sealing member 20 to better resist external forces such as bending and impact. In addition, disposing the support structure at the reinforcing rib can further enhance the load-bearing capacity of these regions, allowing the sealing member 20 to withstand greater weight and higher pressure.

In some embodiments, one of the sealing member 20 and the mounting wall 11 is provided with a snap, and the support structure is a hook. The snap is in a snap-fit connection with the hook.

Enabling the sealing member 20 and the mounting wall 11 to be fixed through the snap-fit connection between the snap and the hook is a convenient and reliable assembly method, enabling quick mounting and disassembly of the sealing member 20 in the energy storage power supply 100.

The snap is disposed at the one of the sealing member 20 and the mounting wall 11 and is an elastic structural member. The snap has a groove or a hole configured to accommodate and lock the hook. When the snap is engaged with the hook, a predetermined amount of preload force can be generated, ensuring the connection stability.

The hook, as a part of the support structure, is disposed at another one of the sealing member 20 and the mounting wall 11. A shape and a size of the hook match those of the snap, allowing the snap to be easily inserted into the groove or the hole of the snap. Once inserted, the hook is locked in place through an elastic action of the snap.

The snap-fit connection between the snap and the hook makes mounting and disassembly of the sealing member 20 simple and quick, eliminating a need for additional tools or complex operational steps.

Reference throughout this specification to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and the spirit of the present disclosure. The scope of the present disclosure shall be defined by the claims as appended and their equivalents.

What is claimed is:

1. An energy storage power supply, comprising:
a plurality of cells comprising electrodes and/or explosion-proof valves;
a housing having a mounting wall, a receiving chamber for receiving the plurality of cells being formed inside the housing, a fixing structure for fixing the plurality of cells being formed at a side of the mounting wall close to the receiving chamber, the fixing structure having through holes corresponding to the plurality of cells, and the electrodes and/or explosion-proof valves of the plurality of cells being in communication with an outside of the receiving chamber through the through holes; and
a sealing member covering a side of the mounting wall away from the receiving chamber to isolate the plurality of cells from an external environment, wherein one of the sealing member and the mounting wall has a groove formed at a periphery of the one of the sealing member and the mounting wall, and another one of the sealing member and the mounting wall has a protrusion formed at a periphery of the other of the sealing member and the mounting wall, the protrusion being inserted into the groove.

2. The energy storage power supply according to claim 1, wherein:
the groove is filled with an adhesive; or
an elastic sealing member is disposed in the groove, the protrusion abutting with the elastic sealing member.

3. The energy storage power supply according to claim 1, wherein the sealing member is a cover plate, and the mounting wall has a mounting recess formed at the side of the mounting wall away from the receiving chamber, wherein:
the through holes are formed at a bottom of the mounting recess;
the cover plate covers the mounting recess;
the groove is formed at a periphery of the mounting recess; and
the protrusion is formed at a periphery of the cover plate.

4. The energy storage power supply according to claim 1, wherein the mounting wall and the sealing member form a receiving space, a busbar being disposed in the receiving space and electrically connected to the electrodes of the plurality of cells.

5. The energy storage power supply according to claim 1, wherein the mounting wall and the sealing member form a receiving space, the explosion-proof valves being in communication with the receiving space through the through holes,
wherein a pressure relief channel is formed in the receiving space, the receiving space being in communication with the receiving chamber or an outside of the housing through the pressure relief channel.

6. The energy storage power supply according to claim 1, wherein the fixing structure is an accommodation recess, the plurality of cells being inserted into the accommodation recess at ends of the plurality of cells, and the through holes being formed at a bottom of the accommodation recess.

7. The energy storage power supply according to claim 1, wherein one of the mounting wall and the sealing member is provided with a support structure abutting with another one of the mounting wall and the sealing member.

8. The energy storage power supply according to claim 7, wherein the support structure is a support post,
wherein one of the mounting wall and the sealing member is provided with the support post, and another one of the mounting wall and the sealing member having a support recess, the support post being inserted into the support recess.

9. The energy storage power supply according to claim 1, further comprising:
a fixing support connected to an inner wall of the receiving chamber to fix the plurality of cells to the fixing structure; and
an inverter disposed in the receiving chamber and electrically connected to the plurality of cells.

10. An energy storage power supply, comprising:
a plurality of cells comprising electrodes and/or explosion-proof valves;
a housing having a mounting wall, a receiving chamber for receiving the plurality of cells being formed inside the housing, a fixing structure for fixing the plurality of cells being formed at a side of the mounting wall close to the receiving chamber, the fixing structure having through holes corresponding to the plurality of cells, and the electrodes and/or explosion-proof valves of the plurality of cells being in communication with an outside of the receiving chamber through the through holes; and
a sealing member covering a side of the mounting wall away from the receiving chamber to isolate the plurality of cells from an external environment, wherein one of the sealing member and the mounting wall is provided with a support structure abutting with another one of the mounting wall and the sealing member.

11. The energy storage power supply according to claim 10, wherein the support structure is a support post,
wherein one of the mounting wall and the sealing member is provided with the support post abutting with another one of the mounting wall and the sealing member.

12. The energy storage power supply according to claim 11, wherein another one of the mounting wall and the sealing member has a support recess, the support post being inserted into the support recess.

13. The energy storage power supply according to claim 10, wherein:
one of the sealing member and the mounting wall is provided with a snap; and
the support structure is a hook, the snap being in a snap-fit connection with the hook.

14. The energy storage power supply according to claim 10, wherein the sealing member is provided with a reinforcing rib, the support structure being disposed at the reinforcing rib.

15. The energy storage power supply according to claim 10, wherein:
one of the sealing member and the mounting wall has a groove formed at a periphery of the one of the sealing member and the mounting wall; and
another one of the sealing member and the mounting wall has a protrusion formed at a periphery of the other of the sealing member and the mounting wall, the protrusion being inserted into the groove.

16. The energy storage power supply according to claim 15, wherein:
the groove is filled with an adhesive; or
an elastic sealing member is disposed in the groove, the protrusion abutting with the elastic sealing member.

17. The energy storage power supply according to claim 10, wherein the sealing member is a cover plate, and the mounting wall has a mounting recess formed at the side of the mounting wall away from the receiving chamber, wherein:
the through holes are formed at a bottom of the mounting recess;
the cover plate covers the mounting recess;
the mounting recess has a groove formed at a periphery of the mounting recess; and
the cover plate has a protrusion formed at a periphery of the cover plate.

18. The energy storage power supply according to claim 10, wherein the mounting wall and the sealing member form a receiving space, the electrodes of the plurality of cells being in communication with the receiving space through the through holes, and a busbar being disposed in the receiving space and electrically connected to the electrodes of the plurality of cells.

19. The energy storage power supply according to claim 10, wherein the mounting wall and the sealing member form a receiving space, the explosion-proof valves being in communication with the receiving space through the through holes,
wherein a pressure relief channel is formed in the receiving space, the receiving space being in communication with the receiving chamber or an outside of the housing through the pressure relief channel.

20. The energy storage power supply according to claim 10, further comprising:
a fixing support connected to an inner wall of the receiving chamber to fix the plurality of cells to the fixing structure; and
an inverter disposed in the receiving chamber and electrically connected to the plurality of cells.
